(19) United States
(12) Patent Application Publication
(10) Pub. No.: US 2009/0092807 A1
(43) Pub. Date: Apr. 9, 2009

(54) Two-way shape memory composite polymer and methods of making

(75) Inventors: Jinlian Hu, Kowloon (CN); Shaojun Chen, Kowloon (CN)

Correspondence Address: JINLIAN HU;THE HONG KONG POLYTECHNIC UNIVERSITY, HUNG HOM, KOWLOON, HK

(73) Assignee: The Hong Kong Polytechnic University, Kowloon (HK)

(21) Appl. No.: 11/906,000

(22) Filed: Oct. 9, 2007

(51) Int. Cl. B32B 7/02; B29C 55/02; B32B 37/12

(52) U.S. Cl. 428/215; 156/60; 264/480

(57) ABSTRACT

The present invention relates to a composite polymer having two-way shape effect, wherein the composite is made of a shape polymer layer, a resin layer, and an adhesive layer. The composite is suitable for inclusion in films, boards, fabrics, and textiles. Methods of making and using are included herein.

### BACKGROUND

Shape memory materials are defined by their capacity to remember their original shape, either after mechanical deformation which is one-way effect (see, FIG. 1(a)), or by cooling and heating, which is a two way effect (see, FIG. 1(b)). This phenomenon is based on a structural phase transformation.

Shape memory polymers are not only sensitive to the thermal energy, but also to light, pH, electricity, and magnetic energies. Thermal-induced shape memory polymers capable of fixing a temporary shape and recovering their original shape after a series of thermo-mechanical treatments have been widely investigated. Shape memory polymers can be sorted into several types, and most of them belonging to thermoplastic polymers, thermoset polymers and hydrogel, etc. Shape memory polymers have advantages over other shape memory materials, such as alloys, low density, high shape recoverability, easy processability, and low cost. Thus, the development and application of shape memory polymers are increasingly drawing attention in the technical community.

Shape memory polymers are generally characterized as phase separated linear block co-polymers having a hard segment and a soft segment. The hard segment is either typically crystalline, with a defined melting point, or amorphous with a higher defined glass phase transition temperature. The soft segment is typically amorphous having a glass transition temperature, or crystalline having a melting point above ambient temperature. Generally, it is substantially less than the melting point or glass transition temperature of the hard segment.

Basic principles of one-way shape memory effects and their application procedure can be best described with their modulus (E)-temperature (T) behavior (see, FIG. 3), where a linear polymer with its crystalline melting temperature (Tm) or amorphous glass transition (Tg) of soft segment being Ts is assumed. Here Tₕ is the softening-hardening transition temperature of fixed phase, where T₁ and Tᵤ are the typical loading and unloading temperatures, respectively. During the primary processing, such as injection molding, the materials are heated above Tₕ, where the previous memories are completely erased. During cooling in the mould, fixed phases emerge as the temperature decreases below Tₕ, and the formation is completed at Ts. Upon further cooling below Ts, soft segments crystallize and the materials are frozen to their glassy state. The shape of this molded specimen is the original shape of the shape memory experiment. The secondary shaping, such as extension, compression, and transfer molding can be performed either at T>Tₛ, or T<Tₛ, when the samples is deformed at T<Tₛ, shape is simultaneously fixed upon completion the deformation, on the other hand, the sample is deformed at high temperature (Tₛ<T<Tₕ), the deformed shape is fixed upon subsequent cooling under constant strain, In both type of shaping, the original shape is recovered at high temperature. The driving force of shape recovery is the elastic strain generated during the deformation, in addition a high glass state modulus (E_{g}) will provide the materials with high rubbery modulus (Eᵣ) with high elastic recovery at high temperature, and a sharp transition from glassy state to rubbery state makes the materials sensitive to temperature variation.

On the basis of this principle, the shape memory effect can be controlled via molecular weight of the soft segment, the mole ratio between hard segment and soft segment, and polymerization process. Several physical properties of SMPs other than the ability to memorize shape are significantly altered in response to external changes in temperature and stress, particularly at the melting point or glass transition temperature of the soft segment. These properties include the elastic modulus, hardness, flexibility, vapor permeability, damping, index of refraction, and dielectric constant.

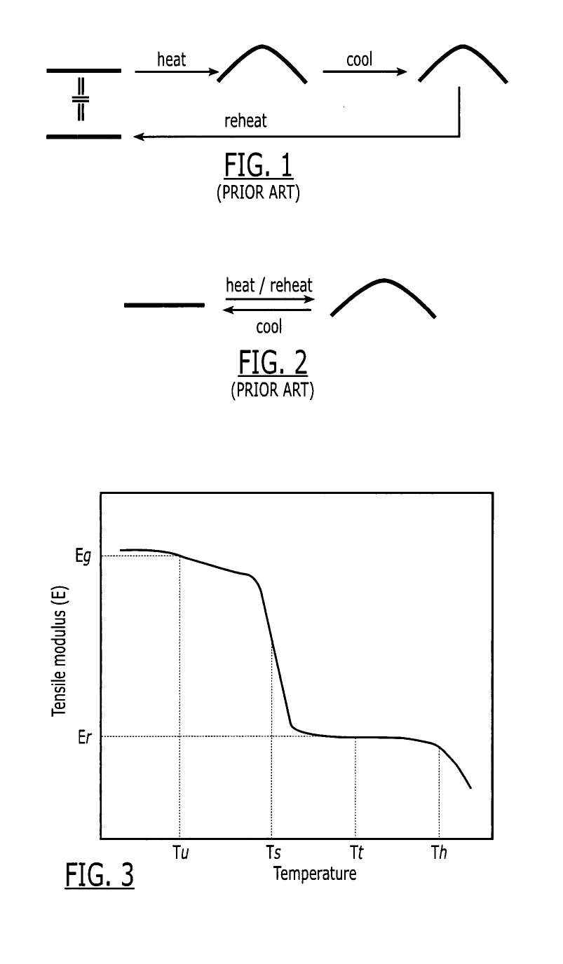

Most of the thermally induced shape memory polymers have a one-way shape memory effect (FIG. 1), i.e., they remember one permanent shape formed at the higher temperature, while many temporary shapes are possible at lower temperatures for which the systems do not have any memory. A two-way thermally induced shape memory polymers will remember two permanent shapes (FIG. 2), one formed at higher temperature and one formed at lower temperature. By thermally cycling the system, these types of polymeric materials will take two different shapes depending on the temperature.

Shape memory polymers have been proposed for various uses, including vascular stents, medicals guidewires, orthodontic wires, vibration dampers, pipe couplings, electrical connectors, thermostats, actuators, eyeglass frames, and brassiere underwires. However, these materials have not yet been widely used, in part because they are relatively expensive. Therefore, composites combining shape memory alloys and polymeric materials have received increasing attention.

It is an object of the present invention to overcome the disadvantages and problems in the prior art.

### DESCRIPTION

The present invention is directed to a composite polymer showing two-way shape memory effect. By changing the temperature, the two-way shape memory composite polymer changes its shape in the direction of one of two permanent shape-types. The composite polymer includes at least one shape memory layer, at least one resin layer, and an adhesive layer, wherein the shape memory layer has mechanical properties dependent on temperature and the resin layer has mechanical properties almost independent from the temperature in the temperature interval of interest. The composite polymer can be included in substrates such as films, boards, fabrics, and textiles, imbibing a two-way memory effect in the substrates. The present invention also includes methods of making such composite polymers including combining a polymer, and a resin layer with a polymer adhesive.

These and other features, aspects, and advantages of the apparatus and methods of the present invention will become better understood from the following description, appended claims, and accompanying drawings where:

FIG. 1 shows a method of using a two-way shape memory polymer, as taught in the prior art;

FIG. 2 shows a method of using a one-way shape memory polymer, as taught in the prior art;

FIG. 3 exhibits a basic principle of shape memory polymers;

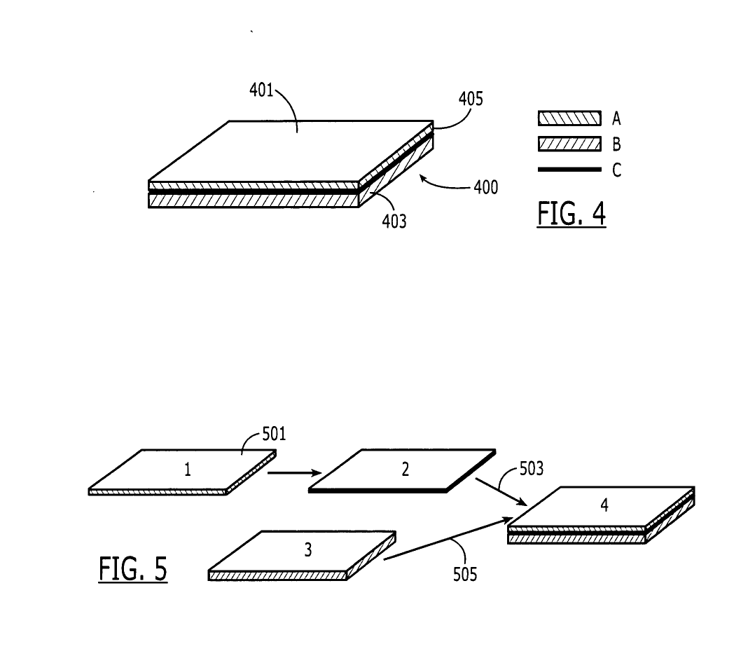

FIG. 4 shows a shape memory polymer of the present invention;

FIG. 5 exhibits of making the present shape memory polymer;

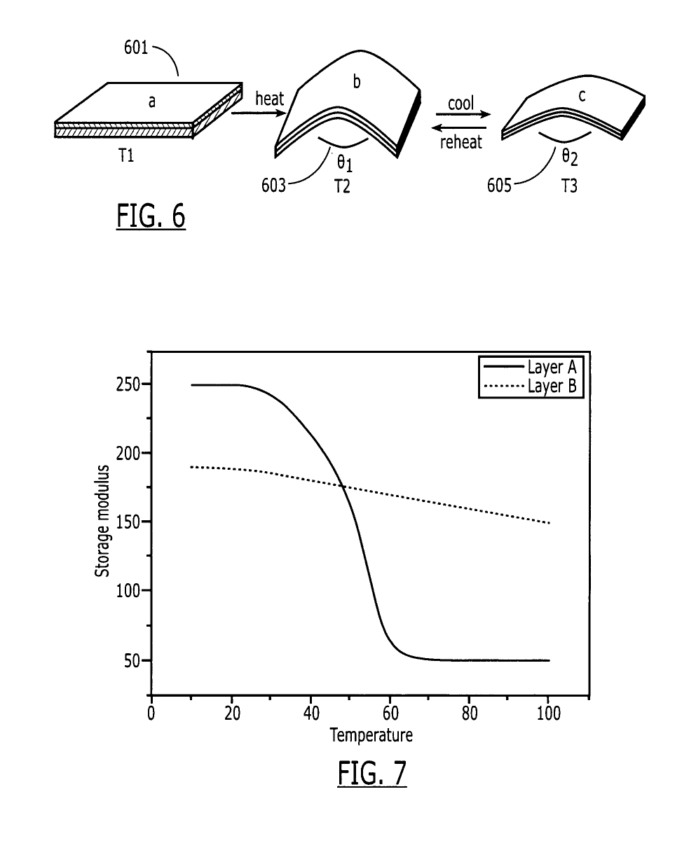

FIG. 6 exhibits a method of using the present shape memory polymer;

FIG. 7 shows the modulus-temperature curve of the preset shape memory polymer; and

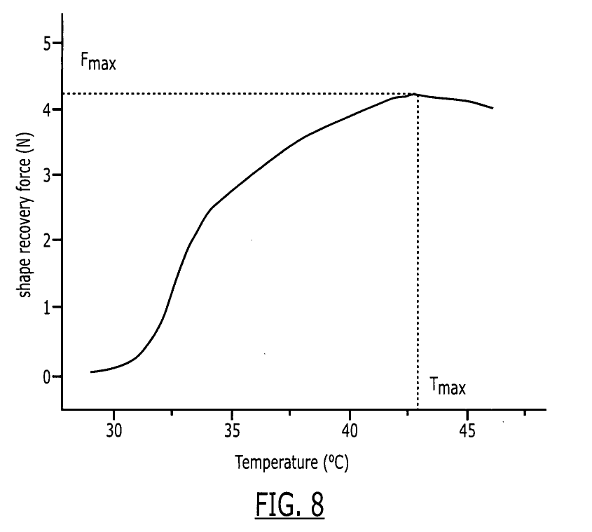

FIG. 8 shows the recovery force-temperature curve of the present shape memory polymer.

The following description of certain exemplary embodiment(s) is merely exemplary in nature and is in no way intended to limit the invention, its application, or uses. Throughout this description, the term Ttrans . . . modulus temperature . . .

Now, to FIGS. 1-8,

FIGS. 1 and 2 show memory effects well-known in the art, specifically a two-way shape memory effect (FIG. 1), and a one-way shape memory effect (FIG. 2). Generally, the one-way shape memory materials remembers one permanent shape. When the shape is deformed to a second shape at a higher temperature or lower temperature with an external force, the second shape can be fixed after it cools to a lower temperature. Furthermore, the second shape can recovery to its original shape after it reheats to the higher temperature. But it can not deform itself without an external force. The thermo-mechanical procedure is stopped after one cycle. In comparison, two-way thermally-induced shape memory materials will remember two permanent shapes, one formed at a higher temperature and one formed at a lower temperature. By thermally cycling the system, these types of polymeric materials will take two different shapes depending on the temperature. As shown in FIG. 1, shape 1 changes to shape 2, when the temperature increase a higher temperature, and shape 2 changes to shape 1 after it cools to a lower temperature. This is a continuous thermo-mechanical procedure. The present invention relates to a shape memory materials having two-way shape memory effect.

A typical modules temperature curve of a one-way memory polymer is shown in FIG. 3. The shape memory polymer shows higher modules at lower temperatures and lower modules at higher temperatures.

The shape memory materials of the present invention are made of composite polymers and include films, boards, fabric, and textiles. The two-way shape memory composite polymer is comprised of at least one layer shape memory polymer.

FIG. 4 shows the structure of a two-way shape memory composite polymer 400 of the present invention. Layer A 401 of the composite polymer 400 is the shape memory polymer layer.

Layer A 401 can be a natural or synthetic shape memory polymer. The shape memory polymer can be selected from the group consisting of polyphosphazenes, poly(vinyl alcohols), polyamides, polyester amides, poly(amino acid)s. polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, polystyrene, polypropylene, polyvinyl phenol, polyvinylpyrrolidone, chlorinated polybutylene, poly(octadecyl vinyl ether) ethylene vinyl acetate, polycaprolactones-polyamide(block copolymer), poly(caprolactone) dimethacrylate-n-butyl acrylate, poly(norbornyl-polyhedral oligomeric silsesquioxane), polyvinyl chloride, urethane/butadiene copolymers, polyurethane block copolymers, styrene-butadiene-styrene block copolymers, and a combination of at least one of the foregoing.

The shape memory polymer 400 can be a thermoset or thermoplastic polymer. In one embodiment, thermoplastic polymer is used due to its ease in molding. Thermosets can be used since they generally are not easily dissolved by the adhesive and are softer than physically crosslinked polymers.

Shape memory polymers are selected based on the desired glass transition temperature(s) (if at least one segment is amorphous) or the melting point(s) (if at least one segment is crystalline). The glass transition temperature is based on the desired applications, taking into consideration the environment of use.

Layer B 403 is a resin layer such as an elastomer or soft plastic. The hardness and modulus of the elastomer generally is between that of rubber and that of plastic. The elastomers have the ability of bend deformation and extended deformation. Suitable elastomers can be, for example, polyurethane elastomers, SBS resin elastomers, silicon elastomers, EVA elastomers, and the like. The soft plastics have a modulus at room temperature above 500 MPa and below 1.0 GPa. The soft plastic can be, for example, polyurethane, polyesters, and the like.

The adhesive layer C 405 is used to combine layer A 401 and layer B 403. Good adhesive polymer with higher adhesive ability is preferable. A lower dissolve ability to layer A 401 and layer B 403 is preferable. Examples of adhesive polymers can include polyurethane adhesive, 502 adhesive, and the like.

FIG. 5 shows a method of preparing a two-way shape memory polymer composite of the present invention.

Firstly, a shape 1 of an original shape of a shape memory polymer is deformed 501 to a shape 2. Shape 2 is then fixed 503 with a shape 3 505 which is a resin layer. Shapes 2 and 3 are combined with an adhesive layer to achieve the polymer composite.

In the present shape memory polymer, lower deformation ratio defined as the deformation between shape 2 and shape 3, shows a lower two-way shape deformation, while a higher deformation ratio makes the two-way shape recovery difficult. A preferred deformation ratio is between 20% to 100% of the non-bent state, which is the state at which the polymer composite is neither positive nor negative from the horizontal (X axis) or vertical (y axis).

In theory, the hardness of the shape memory polymer layer and resin layer both contribute to the shape deformation and shape recovery of the composite polymer. Higher hardness in the shape memory polymer layer provides higher shape deformation force; higher hardness in the resin layer provides higher shape recovery force as well as higher prevention force for shape deformation. A suitable equilibrium of shape deformation force and shape recovery force is desirable in the preparation of two-way shape memory polymer composite. The preferred hardness for the resin layer is above Shore A 90 and below Shore D 80.

The thickness of the shape memory polymer layer and the resin layer influence the two-way shape memory effect. A thicker shape memory polymer layer will provide a higher shape deformation force as well as higher prevention force during shape recovery. A thicker resin layer will prevent shape deformation in the heating process. Generally, for the polymer composite films, the thickness of the shape memory polymer layer is between 0.5 mm to 11.0 mm, and the thickness of the resin layer is between 0.5 mm to 11.0 mm.

FIG. 6 shows the present shape memory polymer in use. The polymer composite (shape a) 601 bends to a curved state (shape b) 603 with an angle θ₁ when heated to a temperature T2. Upon cooling to a temperature T3, the polymer changes shape to shape C 605 with an angle of θ₂. Angles θ₁ and θ₂ mainly depend on the temperature; at different temperatures, the angles are different. Hence, different shapes can be obtained at different temperatures. More than two shapes are memorized in this two-way shape memory composite polymer.

FIG. 7 describes the basic principle for the two-way shape memory effect, attributed to different module temperature dependence. Because the composite polymer is comprised of at least one shape memory layer and at least one resin layer, the modules of the shape memory layer which reflect its mechanic properties in part depend on the temperature, while the resin layer is almost independent from the temperature in the temperature interval of interest. The modules of the resin layer are stronger than the shape memory layer at a higher temperature range. The prevention force of the resin layer increases with the deformation strain as the temperature increases, and the shape recovery force also increases with temperature, as well as decreasing with temperature before it reaches the maximum value (Fₘₐₓ)ₓ, as shown in FIG. 8. The permanent shapes at different temperatures can then be achieved in equilibrium between the recovery force of the shape memory layer, and the prevention force and the resin layer.

### EXAMPLE

Two-way shape memory composite film can be prepared based on shape memory polymers of the present invention. The preparation and properties of the two layers are described below:

### Shape Memory Layer (Layer A):

Shape memory polyurethane with crystalline soft segment is synthesized to be the layer A. Bulk polymerization method is used to synthesize shape memory polyurethane resin herein. The reaction to prepare a pre-polymer was carried out in a 500 mL conical flask equipped with a mechanical stirrer. PHA mixed with MDI for 30 min at 60° C., and followed by the chain extension with BDO for another 30 min. After they were mixed together, the resulting pre-polymer was poured onto a Teflon pan for a post-curing process in a vacuum oven at −80° C. for 12 h; thermo-plastic polyurethane resin (TPU) can then be obtained, also the shape memory polymer urethane solution can be obtained after the thermoplastic urethane dissolved into dimethylformamide (DMF), and shape memory polymer urethane films for the following preparation of composite films were prepared by casting the solution onto a Teflon pan, placed at 60° C. for 24 h and further dried at 75° C. under vacuum of 0.1−0.2 kPa for 24 h.

### Resin Layer (Layer B): Polyurethane Elastomers

Polyurethane with higher hard segment content is synthesized by bulk polymerization method. The reaction to prepare a pre-polymer was carried out in a 500 mL conical flask equipped with a mechanical stirrer. PBA mixed with MDI for 30 min at 60° C., and followed by the chain extension with BDO for another 30 min. After they were mixed together, the resulting pre-polymer was poured onto a Teflon pan for a post-curing process at a vacuum oven at 80° C. for 12 h, and then TPU can be obtained, also the polyurethane (PU) solution can be obtained after the TPU dissolved into DMF, and PU film for the following preparation of composite films were prepared by casting the solution onto a Teflon pan, placed at 60° C. for 24 h and further dried at 75° C. under vacuum of 0.1−0.2 kPa for 24 h.

The main composition and thermal properties of the two layers are summarized in table 1. Herein, the layer A has a typical crystalline soft segment structure, the melting temperature is about 51.48° C., while no crystal is observed in the layer B. Layer A is a typical Tm type shape memory polymer, and Layer B is common polyurethane elastomer.

TABLE 1
the main composition and thermal properties of
layers

| | | | At cooling | | | |
|---|---|---|---|---|---|---|
| | Main | | scanning | | At second heating | |
| | Composition | | curves | | scanning curves | |
| Layer | SSL | HSC (%) | Tc (° C.) | ΔHc (J/g) | Tm (° C.) | ΔHm (J/g) |
| Layer | 6000 | 20 | 27.54 | 31.18 | 51.48 | 30.68 |
| A | | | | | | |
| Layer | 600 | 30 | — | — | — | — |
| B | | | | | | |

### Adhesive Layer C: Polyurethane Adhesive.

Solution polymerization method is introduced to synthesize the polyurethane adhesive solution. Using 250 ml round-bottomed, four-necked flask, the purified 11.0 g PBA with 600 soft segment is reacted with 8.0 g MDI at 80° C. for 2 h in the presence of dibutyl tin dilaurate (DBTDI) as catalyst under a nitrogen atmosphere. 50 ml N,N-DMF is added to the reaction occasionally when necessary. Then 0.9 g 1,4-BDO is fed dropwise into the reaction at 60° C. and reacted for 1 hour. Finally, 130 ml acetone is added into the DMF solution to prepare polyurethane 10% DMF/acetone PU solution.

### Method of Preparation:

Shape memory polyurethane film with thickness 0.2 mm and polyurethane elastomer film with thickness 0.3 mm are prepared as the method given above. Firstly, shape memory films are heated to T_{high} 60° C. within 600 s. Then the film is stretched to ∈ₘ, 200% elongation at Thigh with 10 mm/min stretching rate. After that, the deformed film is cooled to T_{low}, 25° C. Secondly, the fixed film and elastomer films are both coated with 10% DMF/acetone PU solution, and combine the two films together. Shape memory composite film can be achieved after the DMF and acetone are vaporized at room temperature for one week.

### Two-Way Shape Memory Effect:

The shape memory effect of composite film as shown in FIG. 6. It can be observed that the obtained composite film keep its original shape below 35° C., but begin to bend at the temperature above 40° C., and the bend angle θ₁ decrease with the temperature increase, for example, θ₁=80° at 45° C. change to 30° at 55° C. On the other side, the bend angle increases when the temperature decreases. The bend angle changed from θ₂=30° at 55° C. to θ₁=60° at 30° C., and θ₂ are kept to 70° at room temperature in short time. In the second thermo-mechanical cyclic, the composite changes its shape in the direction between the θ₂=70° at room temperature to θ₂=30° at 55° C. The bend angle mainly depends on the temperature in the obtained composite film after the first thermo-mechanical cyclic. In fact, from the second thermo-mechanical cyclic, 95-100% two-way shape memory effect can be achieved in the composite films. This two-way shape memory effect can be repeated more than 100 times. The influence factors:

As discussed above, by changing the temperature, the shape memory polymer changes its shape in the direction of a first permanent shape or a second permanent shape. Each of the permanent shapes results from the equilibrium between the recovery force of shape memory polymer and the prevent force of resin. Therefore, the deformation of the shape memory layer, hardness of two layers, and thickness of the two layers will influence the two-way shape memory effects, which are shown in table 2, table 3, and table 4 respectively.

As the method of preparation described above, the shape memory layers are extended a different deformation ratio, for example 20%, 40%, 60%, 80% and 100%. The resin layer is the same one as above used. The hardness and thickness of two-layer are fixed in this experiment. So we can observe different shapes at different temperatures. The bend angle θ₁ at 55° C. and θ₂ at 25° C. are quite different in each cyclic. According to the two angles, we evaluate its two-way shape memory effect. The results are given in table 2, which shows that the angle change amount increases with the deformation ratio. That is, great shape deformation can be observed in the higher deformation ratio of the shape memory layer. Moreover, in each cycle, the two shapes memorized ability, named two-way shape memory effect here, are beyond 95%.

TABLE 2
The effect of deformation ratio on the shape
memory effect

| | Deformation | | | | Two-way |
|---|---|---|---|---|---|
| | Ratio | θ1 | θ2 | Angle | effect |
| Samples | Of Lay A (%) | at 55° C. | at 25° C. | change | (%) |
| D1 | 20 | 70 | 80 | 10 | >95% |
| D2 | 40 | 60 | 80 | 20 | >95% |
| D3 | 60 | 40 | 80 | 40 | >95% |
| D4 | 80 | 20 | 80 | 50 | >95% |
| D5 | 100 | 10 | 80 | 60 | >95% |

If we selected a resin with a different hardness, from shore A 72 to Shore A 92 herein, combined with the same kind of shape memory layer with hardness of Shore A 91, with controlling the same value of thickness and deformation ratio. It is shown that the bend angle at higher temperature decrease a little in the higher hardness resin sample. The effect of harness on its two-way shape memory effect is shown in table 3. But the recovery angle θ₂ at 25° C. increases greatly, then the angle change increases with the hardness of resin layer. And in each cycle, 95% two-way shape memory effect still can be achieved in every sample under the condition of deformation ratio of shape memory layer. The reason is because the prevention force of resin increases with hardness increase, while the shape recovery force of shape memory layer is constant under the same deformation ratio. The overall shape change increase accompanies by the recovery bend angle increase.

TABLE 3
The effect of hardness on the shape memory effect

| | | | | | | Two- |
|---|---|---|---|---|---|---|
| | Hardness of | Hardness of | θ1 | θ2 | | way |
| | layer | Layer | at | at | Angle | effect |
| samples | A (shore A) | B (shore A) | 55° C. | 25° C. | change | (%) |
| H1 | 91 | 72 | 40 | 60 | 20 | >95% |
| H2 | 91 | 80 | 40 | 70 | 30 | >95% |
| H3 | 91 | 86 | 20 | 100 | 80 | >95% |
| H4 | 91 | 92 | 20 | 110 | 90 | >95% |

Mechanical properties of two layer can be reflected from the modulus as discussed above. As the temperature increases, the mechanical properties of shape memory layer decreases, particularly significant decreases are observed at the switch temperature range. But the mechanical properties are almost independent on the temperature. Therefore, there is unbalance between the recovery force and prevention force. It steers the overall shape of the polymer composite. Accordingly, the thickness of the two layers will influence the two forces direct, and it results in different overall shapes at different temperatures. In table 4, it is shown that no obvious angle change is observed when the resin (layer B) thickness is thinner than the shape memory layer (layer A), while great angle change can be obtained if the thickness ratio (shape memory layer to resin layer) is below 1.0.

In each prepared shape memory polymer composite samples, the shapes at different temperature mainly depend on the temperature. That is, the shapes are almost fixed in different temperature. Above 95%, two way shape memory effect can be achieved almost in each samples. The two-way shape memory effect can be recycled for more than 100 times.

TABLE 4
The effect of thickness on the shape memory effect

| | | Thickness | | | | | |
|---|---|---|---|---|---|---|---|
| | Thickness of | of | | θ1 | θ2 | | Two way |
| | Layer A | Layer B | Ratio of | at | at | Angle | effect |
| Samples | (mm) | (mm) | thickness | 55° C. | 25° C. | change | (%) |
| T1 | 0.36 | 0.27 | 1.33 | 40 | 20 | 20 | >95% |
| T2 | 0.28 | 0.27 | 1.04 | 30 | 10 | 20 | >95% |
| T5 | 0.37 | 0.40 | 0.93 | 250 | 170 | 80 | >95% |
| T3 | 0.35 | 0.52 | 0.67 | 180 | 90 | 90 | >95% |
| T4 | 0.32 | 0.63 | 0.51 | 180 | 90 | 90 | >95% |

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A shape memory composite polymer having two-way shape memory effect, comprising
a shape memory polymer layer having a thickness between 0.5 mm to 11.0 mm;
a resin layer having a thickness between 0.5 mm to 1.0 mm; and
an adhesive layer.

2. The shape memory polymer having two-way shape memory effect of claim 1, wherein said shape memory polymer layer is selected from the group consisting of polyphosphazenes, poly(vinyl alcohols), polyamides, polyester amides, poly(amino acid)s. polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, polystyrene, polypropylene, polyvinyl phenol, polyvinylpyrrolidone, chlorinated polybutylene, poly(octadecyl vinyl ether) ethylene vinyl acetate, polycaprolactones-polyamide(block copolymer), poly(caprolactone) dimethacrylate-n-butyl acrylate, poly(norbornyl-polyhedral oligomeric silsesquioxane), polyvinyl chloride, urethane/butadiene copolymers, polyurethane block copolymers, styrene-butadiene-styrene block copolymers, and a combination of at least one of the foregoing.

3. The shape memory polymer having two-way shape memory effect of claim 1, wherein said resin layer is either an elastomer or soft plastic.

4. A method of making a two-way shape memory polymer, comprising the steps of
deforming a shape memory polymer; and
fixing said deformed shape memory polymer to a resin layer via an adhesive layer.

5. The method of making a two-way shape memory polymer of claim 4, wherein said shape memory polymer is selected from the group consisting of polyphosphazenes, poly(vinyl alcohols), polyamides, polyester amides, poly(amino acid)s. polyanhydrides, polycarbonates, polyacrylates, polyalkylenes, polyacrylamides, polyalkylene glycols, polyalkylene oxides, polyalkylene terephthalates, polyortho esters, polyvinyl ethers, polyvinyl esters, polyvinyl halides, polyesters, polylactides, polyglycolides, polysiloxanes, polyurethanes, polyethers, polyether amides, polyether esters, polystyrene, polypropylene, polyvinyl phenol, polyvinylpyrrolidone, chlorinated polybutylene, poly(octadecyl vinyl ether) ethylene vinyl acetate, polycaprolactones-polyamide(block copolymer), poly(caprolactone) dimethacrylate-n-butyl acrylate, poly(norbornyl-polyhedral oligomeric silsesquioxane), polyvinyl chloride, urethane/butadiene copolymers, polyurethane block copolymers, styrene-butadiene-styrene block copolymers, and a combination of at least one of the foregoing.

6. A process for using a two-way shape memory composite polymer, wherein said two-way shape memory composite polymer has a shape memory polymer attached to a resin layer via an adhesive layer, comprising the steps
applying an energy force to said two-way shape memory polymer;
bending of said two-way shape memory composite an angle θ₁;
decreasing said energy applied to said two-way shape memory;
bending of said two-way shape memory composite an angle θ₂; and
repeating the process.

7. The process for using a two-way shape memory composite polymer in claim 6, wherein bending of said two-way shape memory polymer occurs from 20% to 100% of the non-bent state.

8. The process for using a two-way shape memory composite polymer in claim 6, whereby said energy force is thermal energy, light energy, pH, electrical energy or magnetic energy.

9. The process for using a two-way shape memory composite polymer in claim 6, wherein said energy force is thermal.

10. The process for using a two-way shape memory composite polymer in claim 9, wherein said angle θ₁ bends at 40° C.

11. The process for using a two-way shape memory composite polymer in claim 9, wherein said angle θ₂ bends at 55° C.

12. The process for using a two-way shape memory composite polymer in claim 6, wherein 95-100% two-way memory effect can be achieved from the second thermo-mechanical cycle.

13. The process for using a two-way shape memory composite polymer in claim 6, wherein repeating the process occurs for up to 100 times.
